(19) United States
(12) Patent Application Publication
(10) Pub. No.: US 2017/0117088 A1
(43) Pub. Date: Apr. 27, 2017

(54) IMPULSE VOLTAGE-RESISTANT DISC-WOUND TRANSFORMER

(71) Applicant: Virginia Transformer Corporation, Roanoke, VA (US)

(72) Inventor: Subhas SARKAR, Roanoke, VA (US)

(73) Assignee: VIRGINIA TRANSFORMER CORPORATION, Roanoke, VA (US)

(21) Appl. No.: 14/922,778

(22) Filed: Oct. 26, 2015

(51) Int. Cl. H01F 27/28; H01F 27/24

(52) U.S. Cl. CPC H01F 27/2823; H01F 27/24

(57) ABSTRACT

A transformer coil wound in a disc winding arrangement. Discs may be arranged such that the line lead does not connect to the first disc in the transformer coil but instead to a subsequent disc. This arrangement may improve the capacitance between the initial few discs of the winding, making the impulse voltage distribution more uniform without the use of a static end ring or other impulse voltage distribution controlling alterations.

### BACKGROUND

Transformers to be used in high-voltage applications are often wound as “disc windings.” These come in two common forms, namely sectional disc windings and continuous disc windings. In a sectional disc winding, conductor turns are typically wound radially outwards one on top of the other starting at the surface of the winding former. Cross-overs between adjacent discs are typically made on the inside of the disk pairing, and both “finishes” typically appear at the outer surfaces of their respective discs. The required number of disc pairs may be wound in this way, may be assembled in place, and then may be connected together at the ends by appropriate connectors in order to form a complete winding.

In a continuous disc winding, the final configuration may be the same, but the winding may be completed in such a way as to avoid the need for it to be wound as separate disc pairs; instead, the conductor may continuously be formed around a central core or about a mandrel or similar device. Typically, each disc is formed around a mandrel by winding outwards. Every second disc may then be detensioned and removed, and the turns then reassembled in the reverse order, so that the “start” of that disc is the crossover from the disc adjacent to it and the “finish” is near the surface of the mandrel.

Once assembled, the arrangement of disc windings may be capped with a Static End Ring (SER), which may provide shielding of the transformer against impulse voltages (such as might be caused by lightning). The SER may be placed at the line end of the winding and may be connected to the first disc of the winding. The SER provides capacitance between itself and the first disc, and this capacitance may improve the impulse voltage distribution, making it more linear.

However, certain problems with this arrangement exist. Two SERs must be constructed and connected per limb of the transformer, for a total of six; this increases the cost of each transformer. The use of SERs also results in an increase of the limb height, resulting in an increase in cost compared to a transformer that does not use SERs, an increase in the quantity of oil necessary for the transformer, and an increase in the no-load losses of the transformer, decreasing performance.

### SUMMARY

A transformer coil wound in a disc winding arrangement may be disclosed. Discs may be linearly arranged around a central core, and may be arranged such that the line lead does not connect to the first disc in the transformer coil but instead to a subsequent disc.

Coils may be used in a transformer, such as a three-phase transformer, that has been designed to have greater linearity in impulse voltage distribution. Transformer may include at least one primary and at least one secondary coil, each employing a particular transformer coil winding arrangement, distributed on a core having a low magnetic reluctance and a plurality of limbs. Line connections may be connected to a disc other than the first disc in the transformer coil, thereby improving capacitance between the initial few discs of the winding.

### BRIEF DESCRIPTION OF THE DRAWINGS

Advantages of embodiments of the present invention will be apparent from the following detailed description of the exemplary embodiments. The following detailed description should be considered in conjunction with the accompanying figures in which:

FIG. 1 shows a schematic of an exemplary embodiment of a disc-wound transformer having impulse voltage-resistant properties without the use of SER.

FIG. 2 displays exemplary impulse voltage distribution test results for an exemplary embodiment of an impulse voltage-resistant disc-wound transformer.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

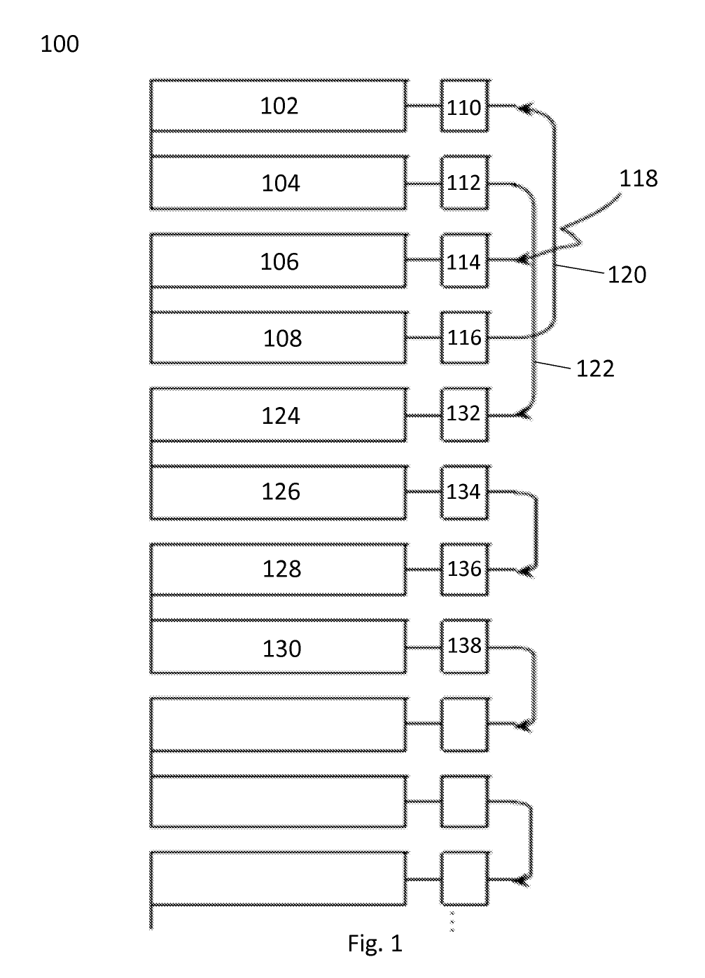

Referring now to exemplary FIG. 1, a schematic of a disc-wound transformer winding 100 having impulse voltage-resistant properties may be shown and described. According to one exemplary embodiment, transformer winding 100 may be used as part of a single-phase transformer; according to a second embodiment, transformer winding 100 may be used in a limb of a three-phase transformer, as a primary winding, secondary winding, or both. Other applications of transformer winding 100 may also be envisioned. Transformer winding 100 may have a number of disc pairings, such as a first disc pairing 102, 104, a second disc pairing 106, 108, and so on, as desired. As many or as few disc pairings may be employed as desired and as appropriate for the application or alternative exemplary embodiments.

Discs, such as discs 102, 104, and the like, may have a length of insulated electrical conductor, for example copper, aluminum, another high-conductivity material, or another suitable conductor, that may be radially disposed around a central core and wound upon itself. Discs may be generally coil- or donut-shaped, and may have a hollow inner portion and a flat or substantially flat or planar outer portion. Discs may be formed by sectional winding, continuous winding, or otherwise as desired. Alternatively, other transformer coils may be used. For example, a shell form or pancake form transformer coil arrangement may be used instead, with coils substituting for discs. When arranged in place around the central core, discs may form a single continuous conductor; if formed by a method other than continuous winding, for example sectional winding, discs may be linked together by connectors, joints, or by another desirable linkage.

Discs may be arranged on a central core or around a mandrel or similar forming device; central core may be, for example, a soft iron core, a laminated steel core, another material with a low magnetic reluctance, or another suitable material. Alternatively, an air or other fluid core may be used. Core, if solid, and discs may be substantially round, elliptical, square, rectangular, or any other shape desired; core and discs need not be the same shape. Multiple different core constructions may be envisioned. According to one embodiment, the core may be a three-limb core, and may serve as the basis for a three-limb core-type transformer having three sets of transformer windings 100, one on each core. According to a second embodiment, the core may be a five-limb core, and may serve as the basis for a five-limb shell-type transformer having three sets of transformer windings 100, one on each of the three centermost cores. Other core constructions may also be used, as desired.

Discs in a disc pairing, for example disc pairing 102, 104, may be linked to one another by a linkage or connection located on the inner portion of the disc. Discs, for example disc 102, may also each have a “finish,” for example finish 110, which may be connected to another disc or to another input or output. According to exemplary embodiments where the disc is a wound coil, the first linkage may be one end of the coil (the “linkage end”) and the finish 110 may be the other end of the coil (the “finish end”). According to an exemplary embodiment, a portion of the disc pairings that may be used in transformer winding 100, for example the disc pairings 124, 126 and 128, 130, may be connected to the adjoining disc pairings by the finishes. For example, the finish 134 of disc 126 may be connected to the finish 136 of the adjacent disc 128, and disc 130 connected to an adjoining disc by its own finish 138. This pattern may continue through a substantial portion of the transformer winding 100.

According to an exemplary embodiment, the arrangement and interconnection of the two disc pairings nearest the end 102, 104 and 106, 108 may differ from the arrangement of the remainder of the disc pairings. According to such an embodiment, a line connection 118, which may, depending on placement, be the top line lead or the bottom line lead, may be connected to the finish 114 of disc 106. Disc 106 may be in a pairing with disc 108, and disc 108 may be connected via its finish 116 to the finish of disc 102. Disc 102 may be in a pairing with disc 104, and disc 104 may be connected to disc 124. Disc 126, paired with disc 125, may be connected to the next adjacent disc 128, and this pattern may continue. Effectively, this pattern sandwiches the second disc pairing, connected to the line connection, in between the first and third disc pairings. The connection of the line connection 118 to the wound coil pairing 106, 108 second from the end of the transformer winding 100 instead of to the endmost coil pairing 102, 104 may improve the capacitances between the initial few discs of the winding and thereby makes the impulse voltage distribution more linear, without the use of SER.

Alternatively, a different disc may be chosen for the line connection 118. For example, disc 124 may be used instead, sandwiching this disc between two disc pairings on the one side and the remainder of the transformer winding 100 on the other. This may potentially further improve the impulse voltage distribution of the transformer. (The disc to which the line connection is connected may be referred to as a “line connection disc.” If placed on a particular winding, such as a primary or secondary winding, it may be referred to in part by the name of that winding, for example as a “primary line connection disc” or a “secondary line connection disc.”) The placement of discs near the top line connection and near the bottom line connection may be mirrored in both the primary and secondary windings; for example, if on the topmost winding of the transformer coil 100 the top line lead 118 goes to the third topmost disc 106 and skips the topmost two 102, 104, then the bottommost winding of the transformer coil 100 may likewise skip the bottommost two discs 102, 104. Alternatively, the primary and secondary windings may skip different numbers of discs. If multiple transformer coils 100 are placed on the same core, for example as part of a three-phase transformer, they may be identically wound or may have different windings.

Optionally, a static end ring or static ring may be used in conjunction with this transformer winding 100. Because of the capacitance improvement offered by the winding 100 in question, this may allow a relatively unobtrusive SR or SER with lower capacitance to be used than would otherwise be necessary. This may reduce its cost and reduce the downsides of its addition while still contributing beneficially to mitigating the effects of impulse voltage. Other devices and features for mitigating the effects of an impulse voltage or for making it more uniform, such as an angle ring or cap, may also be employed.

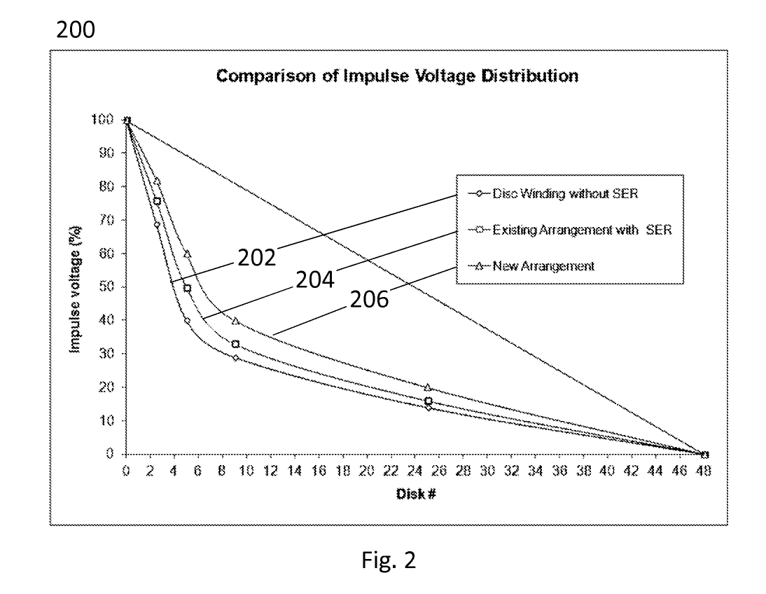

FIG. 2 displays an exemplary comparison of impulse voltage distribution test results 200 for three transformer configurations. A transformer 202 having a disc coil winding arrangement but which does not have a static end ring may be compared to a transformer 204 having a disc coil winding arrangement and which does have a static end ring, and may be further compared to a transformer 206 having a disc coil winding arrangement configured as described in FIG. 1. Transformer configurations may be substantially identical in performance characteristics; according to one exemplary embodiment, tested transformers 202, 204, 206 may all have ratings of 5000 kVA and 69000 V. According to such an embodiment and as displayed in FIG. 2, transformer 206 may exhibit a markedly more linear response to the impulse voltage than either of the other transformers 202, 204, demonstrating that transformer 206 has markedly better impulse voltage withstand properties as compared to transformers having the other two tested winding configurations 202, 204.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A disc coil winding arrangement for a transformer, comprising:
a central core having a low magnetic reluctance;
a plurality of discs formed from insulated electrically conductive material, each of the plurality of discs having a linkage end and a finish end;
each of the plurality of discs further having a substantially flat outer portion, and a hollow central portion that is larger in size than the cross-section of the central core;
the plurality of discs further being arranged in a linear arrangement and being disposed around the central core;
the plurality of discs further having a line connection disc, the line connection disc having a finish end connected to a line connection;
the line connection disc having at least one disc in the plurality of discs located on either of its sides such that the line connection disc is not disposed on one end of the plurality of discs.

2. The winding arrangement of claim 1, wherein the plurality of discs form a single continuous conductor.

3. The winding arrangement of claim 1, wherein the plurality of discs is formed by sectional winding.

4. The winding arrangement of claim 1, wherein the plurality of discs is formed by continuous winding.

5. The winding arrangement of claim 1, wherein each of the discs in the plurality of discs is connected to one other disc by the linkage ends of each disc.

6. The winding arrangement of claim 1, wherein the line connection disc is connected in a first disc pairing to one other disc by the linkage end, and wherein the endmost disc of the linear arrangement of the plurality of discs is connected in a second disc pairing to one other disc by the linkage end, and wherein the finish end of one of the discs of the first disc pairing is connected to the finish end of one of the discs of the second disc pairing.

7. A transformer, comprising:
a core having a low magnetic reluctance and having a plurality of limbs;
at least one primary winding disposed on one of the plurality of limbs of the core, each primary winding comprising a plurality of discs formed from insulated electrically conductive material, each of the pluralities of discs having at primary line connection disc, and each of these primary line connection discs having at least one disc in the plurality of discs located on either side of the primary line connection disc such that the primary line connection disc is not disposed on one end of the plurality of discs;
at least one secondary winding disposed on one of the plurality of limbs of the core, each secondary winding comprising a plurality of discs formed from insulated electrically conductive material, each of these pluralities of discs having a secondary line connection disc, and each of these secondary line connection discs having at least one disc in the plurality of discs located on either side of the secondary line connection disc such that the secondary line connection disc is not disposed on one end of the plurality of discs.

8. The transformer of claim 7, wherein discs in at one plurality of discs are formed by sectional winding.

9. The transformer of claim 7, wherein discs in at least one plurality of discs are formed by continuous winding.

10. The transformer of claim 7, wherein discs in at least one plurality of discs are linked to other discs in pairings of two.

11. The transformer of claim 7, wherein there is one disc in the plurality of discs separating each of the primary line connection discs from one end of the plurality of discs.

12. The transformer of claim 7, wherein there is one disc in the plurality of discs separating each of the secondary line connection discs from one end of the plurality of discs.
